(19) United States
(12) Patent Application Publication
(10) Pub. No.: US 2026/0339628 A1
(43) Pub. Date: Oct. 29, 2026

(54) AI INFERENCE COMPILER AND RUNTIME TOOL CHAIN

(71) Applicant: Tesla, Inc., Austin, TX (US)

(72) Inventors: Srihari SAMPATHKUMAR, Austin, TX (US); Farzad KHORASANI, Austin, TX (US); Alexandre RAMES, Austin, TX (US); Igor SHEVCHENKO, Austin, TX (US); Zhenhua YU, Austin, TX (US)

(73) Assignee: Tesla, Inc., Austin, TX (US)

(21) Appl. No.: 19/116,245

(22) PCT Filed: Sep. 29, 2023
(86) PCT No.: PCT/US2023/034233

§ 371 Date: Mar. 27, 2025

Related U.S. Application Data
(60) Provisional application No. 63/377,954, filed on Sep. 30, 2022.

(51) Int. Cl. G06F 8/41

(52) U.S. Cl. CPC G06F 8/41

(57) ABSTRACT

Embodiments include systems and methods for processing sensor data and generating operational instructions of hardware of egos (e.g., autonomous vehicles, robots). The ego includes any number of machine-learning architectures, often neural network architectures, for processing sensor data and recognizing the environment around the ego and making decisions on the ego's behavior. The neural network architectures of the ego ingest sensor data and execute any number of operations related to a particular domain or task, such as object recognition or path planning, using the sensor data. A graph partitioner is trained to assign functions in the software of the neural networks and the sensor data to certain hardware processing units. Several compilers are used to generate the instructions based upon the assigned type of processing unit.

### CROSS-REFERENCE TO RELATED APPLICATION

This application claims priority to U.S. Provisional Application No. 63/377,954, filed Sep. 30, 2022, which is incorporated herein by reference in its entirety for all purposes.

### TECHNICAL FIELD

The present application relates generally to implementing neural network architectures for autonomous vehicles or other autonomous electronics, and more specifically to a system and method for remotely and efficiently compiling and deploying such neural network architectures.

### BACKGROUND

Autonomous navigation technology used for autonomous vehicles and robots (sometimes referred to as “egos”) has become ubiquitous due to rapid advancements in computer technology. These advances allow for safer and more reliable autonomous navigation of egos. Egos often need to navigate through complex and dynamic environments and terrains that may include vehicles, traffic, pedestrians, cyclists, and various other static or dynamic obstacles. Understanding the egos' surroundings is necessary for informed and competent decision-making to avoid collisions. This includes developing and deploying complex neural network architectures on the egos.

Increases in data volume and feature sophistication naturally raises problems of resource demands, requiring solutions for improving computational efficiencies in both the hardware and software components of the egos. This requires sophisticated mechanisms for compiling and deploying the neural network architectures on the egos. In some circumstances, the challenges are heightened by, for example, remote deployment from a software development source to remote egos, and/or deploying software updates of the neural network architectures to predefined and fixed execution-hardware of the ego, among others.

### SUMMARY

Embodiments described herein include systems and methods addressing various shortcomings of the art and may provide various additional or alternative benefits as well. The embodiments include hardware and software configurations that improve upon performance in processing sensor data by software components and computational hardware of egos (e.g., autonomous vehicles, robots). The ego includes any number of machine-learning architectures, often neural network architectures, for processing sensor data and recognizing the environment around the ego and making decisions on the ego's behavior. The neural network architectures of the ego ingest sensor data and execute any number of operations related to a particular domain or task, such as object recognition or path planning, using the sensor data. Any number of compilers transform the software functions of the neural network architectures and the sensor data into machine-code execution instructions for execution by the hardware components.

Embodiments may include a method comprising obtaining, by a computer, software programming comprising a plurality of functions of a plurality of sub-neural networks of a neural network architecture; assigning, by the computer, the one or more sub-neural networks to a plurality of processing units of the ego, wherein for each sub-neural network the computer assigns a processing unit to compute the plurality of functions of the sub-neural network; and generating, by the computer, a plurality of execution instructions for the plurality of processing units by executing a plurality of compilers on the plurality of functions of each sub-network. For each execution instruction, the computer uses a compiler of the plurality of compilers according to the processing unit of the ego assigned to the plurality of functions of the sub-neural network.

The method may include generating, by the computer, a computer file comprising the plurality of execution instructions for the plurality of processing units to execute the plurality of sub-neural networks.

The method may include transmitting, by the computer, the computer file to the ego.

At least one execution instruction may cause a circuit of the ego comprising the plurality of chips to operate in an extended compute mode for parallel execution of the plurality of execution instructions.

At least one execution instruction may instruct a circuit of the ego comprising a plurality of chips including the plurality of processing units to operate in a redundancy mode for primary execution of the plurality of execution instructions by a primary chip of the plurality of chips.

The method may include applying, by the computer, a schedule optimizer engine on the execution instructions to generate an execution schedule of the execution instructions, the schedule optimizer engine comprising neural network layers trained to generate the execution schedule for minimizing latency.

The one or more processing units may include at least one of a GPU, a CPU, or an accelerator device.

The one or more processing units may be heterogenous, including at least two types of processing units.

The computer may assign the processing unit of the plurality of processing units of the ego to apply the sub-neural network according to one or more graphs representing a circuit architecture of the ego having the plurality of processing units.

The method may include training, by the computer, the one or more sub-neural networks for quantization awareness training based upon the one or more processing units, by applying each sub-neural network on a training dataset comprising data with an intended quantization characteristic.

Embodiments may include a system comprising: a computer comprising a processor, configured to: obtain software programming comprising a plurality of functions of a plurality of sub-neural networks of a neural network architecture; assign the one or more sub-neural networks to a plurality of processing units of the ego, wherein for each sub-neural network the computer assigns a processing unit to compute the plurality of functions of the sub-neural network; and generate a plurality of execution instructions for the plurality of processing units of the ego by executing a plurality of compilers on the plurality of functions of each sub-neural network. For each execution instruction, the computer uses a compiler of the plurality of compilers according to the processing unit of the go assigned to the plurality of functions of the sub-neural network.

The computer may be further configured to generate a computer file comprising the plurality of execution instructions for the plurality of processing units to execute the plurality of sub-neural networks.

The computer may be further configured to transmit the computer file to the ego.

At least one execution instruction may cause the plurality of chips of the ego to operate in an extended compute mode for parallel execution of the plurality of execution instructions.

At least one execution instruction may cause the plurality of chips of the ego to operate in a redundancy mode for primary execution of the plurality of execution instructions by a primary chip of the plurality of chips.

The computer may be further configured to apply a schedule optimizer engine on the execution instructions to generate an execution schedule of the execution instructions. The schedule optimizer engine comprises neural network layers trained to generate the instructions for minimizing latency.

The plurality of processing units may include at least one of a GPU, a CPU, or a accelerator device.

The plurality of processing units may be heterogenous, including at least two types of processing units.

The computer may assign the processing unit of the plurality of plurality of processing units of the ego to the sub-neural network according to one or more graphs representing a circuit architecture of the ego having the plurality of processing units.

The computer may be further configured to train the one or more sub-neural networks for quantization awareness training based upon the one or more processing units, by applying each sub-neural network on a training dataset stored in a database, the training dataset comprising data with an intended quantization characteristic.

Embodiment may include an ego comprising a circuit board comprising a plurality of system-on-chip (SOC) devices and a plurality of microcontrollers corresponding to the SOC devices; and a processor of a SOC device configured to: transmit an initial timing message to a first microcontroller at an initial time according to a kernel clock of the processor; receive a response message from the first microcontroller indicating a response time at a first controller clock of the first microcontroller; determine a completion time according to the kernel clock of the processor, in response to receiving the response message from the first microcontroller; compute an error rate for the kernel clock representing a difference between the kernel clock of the processor and the controller clock of the first microcontroller, based upon the initial clock time, the completion time, and the response time; and adjust a frequency of the kernel clock based upon the error rate to reduce the error rate between the kernel clock and the first controller clock.

The processor of the SOC device is configured to transmit the initial timing message in response to receiving a boot instruction from the first microcontroller.

The first microcontroller coupled to the processor may be configured to: compute a second error rate representing a difference between the first controller clock of the first microcontroller and a second controller clock of the a second microcontroller, based upon the initial clock time between the first microcontroller and the second microcontroller, the completion time between the first microcontroller and the second microcontroller, and the response time between the first microcontroller and the second microcontroller; and adjust a second frequency of the second controller clock based upon the second error rate to reduce the second error rate between the first controller clock and the second controller clock.

The first microcontroller is configured to determine whether the difference between first controller clock of the first microcontroller and the second controller clock satisfies a threshold difference.

The first microcontroller is configured to transmit the initial timing message in response to performing a boot function of the first microcontroller.

A second microcontroller is configured to perform a reboot function, and wherein a second controller clock of a second microcontroller is updated to match the first controller clock of the first microcontroller indicated in a timing message received at the second microcontroller from the first microcontroller for the reboot function.

Embodiments may include a method comprising: transmitting, by a processor of a system-on-chip (SOC), an initial timing message to a first microcontroller at an initial time according to a kernel clock of the processor; receiving, by the processor, a response message from the first microcontroller indicating a response time at a first controller clock of the first microcontroller; in response to receiving the response message, determining, by the processor, a completion time according to the kernel clock of the processor; computing, by the processor, an error rate for the kernel clock representing a difference between the kernel clock of the processor and the first controller clock of the first microcontroller, based upon the initial clock time, the completion time, and the response time; and adjusting, by the processor, a frequency of the kernel clock based upon the error rate to reduce the error rate between the kernel clock and the first controller clock.

The method may include receiving, by the processor, a boot instruction from the first microcontroller, wherein the processor of the SOC device is configured to transmit the initial timing message in response to receiving the boot instruction.

The processor and the first microcontroller exchange one or more timing messages at a boot time in accordance with a bootloader function of the first microcontroller.

The method may include computing, by the first microcontroller, a second error rate representing a difference between the first controller clock of the first microcontroller and a second controller clock of a second microcontroller, based upon the initial clock time between the first microcontroller and the second microcontroller, the completion time between the first microcontroller and the second microcontroller, and the response time between the first microcontroller and the second microcontroller; and adjusting, at the second microcontroller, a second frequency of the second controller clock based upon the second error rate to reduce the second error rate between the first controller clock and the second controller clock

Embodiments may include an ego comprising: a circuit board comprising a plurality of system-on-chip (SOC) devices and a plurality of microcontrollers corresponding to the SOC devices; and a first microcontroller configured to: transmit an initial timing message to a second microcontroller at an initial time according to a first controller clock of the first microcontroller; receive a response message from the second microcontroller indicating a response time at a second controller clock of the second microcontroller; determine a completion time according to the first controller clock of the first microcontroller, in response to receiving the response message from the second microcontroller; compute an error rate representing a difference between the first controller clock of the first microcontroller and the second controller clock of the second microcontroller, based upon the initial clock time, the completion time, and the response time; and adjust a frequency of the second controller clock based upon the error rate to reduce the error rate between the first controller clock and the second controller clock.

The first microcontroller may be configured to determine whether the difference between first controller clock of the first microcontroller and the second controller clock satisfies a threshold difference.

The first microcontroller may be further configured to transmit a boot signal to a kernel of a processor of a SOC coupled to the first microcontroller.

The processor of the SOC may be configured to: compute a second error rate representing a difference between a kernel clock of the kernel of the processor and the first controller clock of the first microcontroller, based upon the initial clock time between the SOC and the first microcontroller, the completion time between the SOC and the first microcontroller, and the response time between the SOC and the first microcontroller; and adjust a kernel frequency of the kernel clock based upon the error rate to reduce the error rate between the kernel clock and the first controller clock.

The second microcontroller may be configured to transmit a second boot signal to a second kernel of a second processor of a second SOC coupled to the second microcontroller.

The second microcontroller may perform a reboot function. The second controller clock is updated to match the first controller clock indicated in a timing message received at the second microcontroller from the first microcontroller.

Embodiments may include a method comprising transmitting, by a first microcontroller coupled to a first SOC, an initial timing message to a second microcontroller coupled to a second SOC at an initial time according to a first controller clock of the first microcontroller; receiving, by the first microcontroller, a response message from the second microcontroller indicating a response time at a second controller clock of the second microcontroller; determining, by the first microcontroller, a completion time according to the first controller clock of the first microcontroller, in response to receiving the response message from the second microcontroller; computing, by the first microcontroller, an error rate representing a difference between the first controller clock of the first microcontroller and the second controller clock of the second microcontroller, based upon the initial clock time, the completion time, and the response time; and adjusting, by the first microcontroller, a frequency of the second controller clock based upon the error rate to reduce the error rate between the first controller clock and the second controller clock.

The first microcontroller may be configured to determine whether the difference between first controller clock of the first microcontroller and the second controller clock satisfies a threshold difference.

The method may include transmitting, by the first microcontroller, a boot signal to a kernel of a processor of a SOC coupled to the first microcontroller.

The method may include computing, by a processor of the first SOC, a second error rate representing a difference between a kernel clock of the kernel of the processor and the first controller clock of the first microcontroller, based upon the initial clock time between the SOC and the first microcontroller, the completion time between the SOC and the first microcontroller, and the response time between the SOC and the first microcontroller; and adjusting, by the processor of the first SOC, a kernel frequency of the kernel clock based upon the error rate to reduce the error rate between the kernel clock and the first controller clock.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system for egos, according to an embodiment.

FIG. 1B illustrates various sensors associated with vehicle (or other type of ego), according to an embodiment.

FIG. 1C illustrates the components of an ego, according to an embodiment.

FIG. 1D illustrates certain hardware and software components of the ego for performing full or partial self-driving (SD) operations, according to an embodiment.

FIG. 1E illustrates certain hardware and software components of the ego for clock synchronization, according to an embodiment.

FIGS. 2A-2B illustrate data flow amongst hardware and software computing components of a computing system of an ego, according to an embodiment.

FIG. 2C illustrates the execution instructions arranged into an execution schedule for execution by IC hardware components of the system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Embodiments described herein include systems and methods addressing various shortcomings of the art and may provide various additional or alternative benefits as well. The embodiments include hardware and software configurations that improve upon performance in processing sensor data by software components and computational hardware of egos (e.g., autonomous vehicles, robots). The ego includes any number of machine-learning architectures, often neural network architectures, for processing sensor data and recognizing the environment around the ego and making decisions on the ego's behavior.

At a software level, a local or remote computer processing device of the ego may execute various software routines of the neural network architecture (or other machine-learning architecture). The software defines layers and functions of the neural network architecture or define a hierarchical-parent neural network architecture and one or more hierarchical-child neural network architectures (sometimes referred to child networks or sub-networks). The neural network architectures of the ego ingest sensor data and execute any number of operations related to a particular domain or task, such as object recognition or path planning, using the sensor data.

At a hardware level, the ego includes various types of computing hardware resources, including various integrated circuit (IC) components and related firmware or controllers, among others. The computing hardware components realize and perform the software functions of the neural network architectures using the sensor data. Any number of compilers transform the software functions of the neural network architectures and the sensor data into machine-code execution instructions for execution by the hardware components.

Embodiments include various software routines for improving the performance and efficiency of processing the sensor data within the computation hardware by partitioning the sensor data into multiple data partitions or portions and partitioning the neural network architecture structure in sub-networks. The software routines may include machine-learning architecture includes neural network layers defining a graph partitioner. The graph partitioner is configured and trained to assign the sensor data portions to certain functions of the sub-networks, and then assign one or more hardware processing units (e.g., GPUs, CPUs, specialized-hardware AI accelerator devices) to perform a function using the sensor data portion. The neural network of the graph partitioner is trained to identify and assign the function to apply to the sensor data based upon, for example, the types of sensor data or types of features of the sensor. In some embodiments, the graph partitioner may include hardcoded or preconfigured mappings between the types of sensor data or features and the software functions of the neural network architectures.

The graph partitioner may be configured and trained to identify and assign the functions sensor data portion to a particular hardware processing unit. The graph partitioner may be trained, for example, to select the hardware processing unit for performing a function based upon desired performance behaviors or results, such as optimizing efficiency of the computing hardware, maximizing a performance metric of the computing hardware, or minimizing performance metric of the computing hardware. For instance, the graph partitioner may be trained to assign certain sophisticated functions to specially-designed AI accelerator devices.

Embodiments may include a heterogenous collection of hardware processing units. The graph partitioner may be trained to identify and assign compilers capable of generating execution instructions having machine-code compatible with the assigned processing unit. The graph partitioner is trained to, for example, assign processing units to execute functions in order to optimize functionality of the computing hardware, maximize a certain performance behavior of the computing hardware, or minimize a certain performance behavior. By training the graph partitioner to dynamically assign heterogenous processing units to execute specified functions of the neural network architecture, the graph partitioner optimizes execution of the neural network functions within the hardware. This leads to improved accuracy and performance of the neural network architecture in analyzing the sensor data.

Embodiments include a schedule optimizer having preconfigured, or trained to identify, relationships between different partitions of the sensor data and the neural network architecture. The schedule optimizer is used to combine multiple compiled pieces of code (e.g., execution instructions) into one or more executable files. In some cases, the link generates a sequencing or arrangement for executing the instructions by the hardware components. In these cases, the schedule optimizer may generate an execution schedule that minimizes latency by applying a trained neural network architecture of the linking engine to determine, for example, the dependencies between the data, the functions to be performed by the processing units, and the processing units assigned to perform the functions. The linking engine may then identify an execution schedule to optimize performance, relative to the constraints of the dependencies. In this way, the schedule optimizer ensures the execution instructions are organized in a way that reduces delays and latency, allowing for improved real-time processing of the sensor data.

Downstream hardware and software of the ego may ingest the outputs generated by the SD circuit executing the neural network architecture, such as trajectory, speed, and other navigational determinations of the path planning network, to operate or maneuver the ego within an environment.

The hardware of the ego includes an SD circuit (e.g., integrated circuit (IC) board) having two (or more) system-on-chip (SOC) chips, or similar types of IC devices. The SOC chips may perform functions of certain neural network architectures by executing the execution instructions compiled as execution libraries from the source code of the particular neural network architectures. A server of a development system trains the neural network architectures on historic and/or current sensor data and outputs of other neural network architectures. The server then applies the compiler toolchain described herein on source code and data of the trained neural network architectures to generate the execution libraries. The neural network architecture of the graph partitioner is trained to assign the portions of the execution libraries to corresponding processing units of the SOC chips. In some cases, a first neural network architecture is programmed to require or expect data inputs from a second neural network architecture. When the first SOC chip loads and executes the execution instructions for the first neural network architecture and the second SOC chip loads and executes the execution instructions for the second neural network architecture, then the second SOC chip will require or expect data inputs from the first SOC chip. The SD circuit includes a bus that allows the SOC chips to communicate data signals.

Embodiments include hardware and/or software components within circuit components of the ego that allow the SOC chips of an SD circuit board to operate as though the SOC chips are functioning on a single synchronized clock. In some embodiments, the SD circuit includes two (or more) SOC chips, each coupled to a coupled to an SOC microcontroller, which may be any microcontroller device or similar processing circuit unit that maintains a chip-clock for the respective SOC chips. The SOC chips are booted contemporaneously by an ego computer processor, such that the SOC clocks of the SOCs are as near to one another as possible. Each SOC chip includes an operating system (OS) kernel that manages certain operations of the respective SOC chip. At a preconfigured interval, each SOC chip exchanges time messages with the microcontroller of the respective SOC to confirm the SOC's kernel-clock is within a threshold distance from the SOC's controller clock, and correct or adjust the SOC's microcontroller as needed. In this way, each SOC chip maintains clock synchronization between the SOC's OS kernel and the SOC's microcontroller. Moreover, at a preconfigured interval, the SOC microcontrollers exchange time messages to confirm that a first controller-clock of a first SOC microcontroller is within a threshold distance of a second SOC controller clock of a second SOC microcontroller. If beyond the threshold distance, the second microcontroller may be corrected or adjusted to reduce the distance between the controller-clocks. In this way, the microcontrollers maintain clock synchronization between the SOC microcontrollers and, by extension, maintain clock synchronization between the SOC chips.

In some embodiments, an SD circuit includes a controller or other processing unit that maintains clock synchronization between the SOC chips based upon interpreting timestamps of sensor inputs (e.g., timestamps of camera inputs) and translating the timestamps between the SOC chips according to a difference between each SOC chip's current chip-clock.

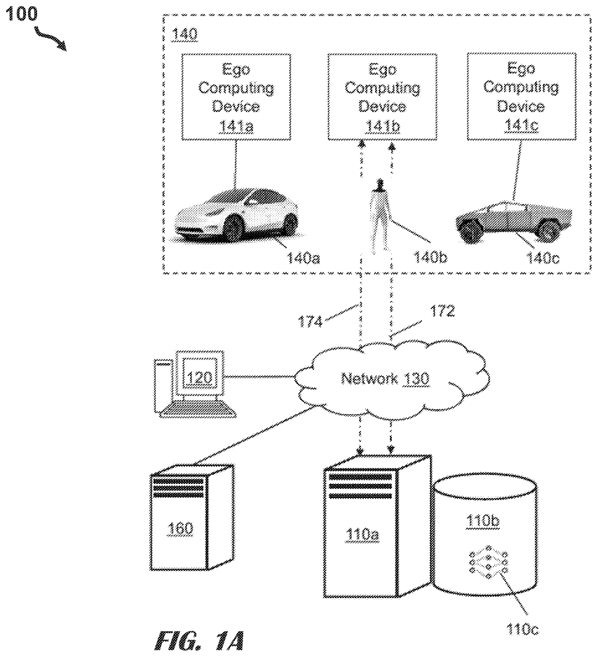

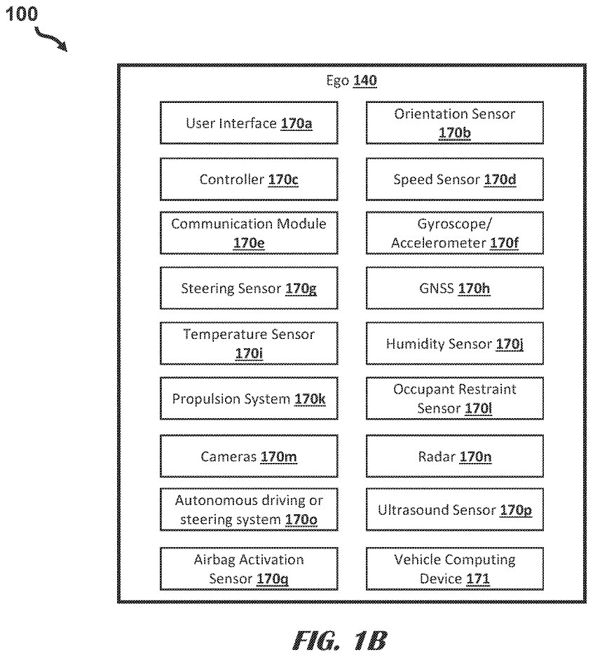

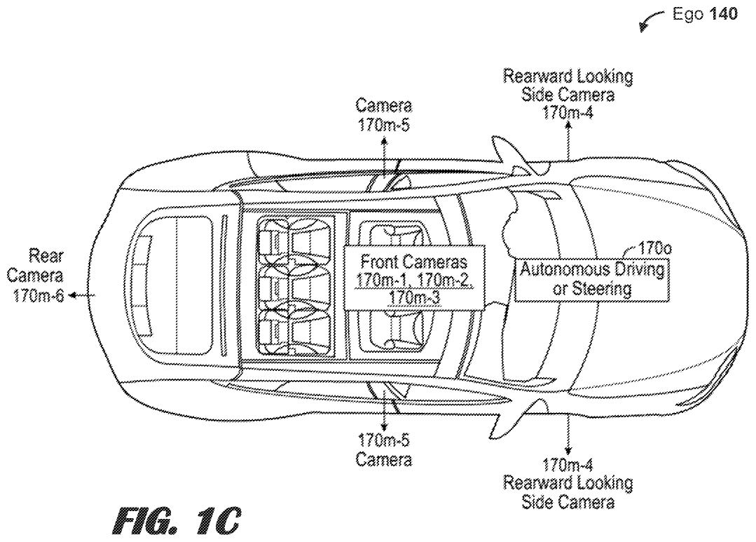

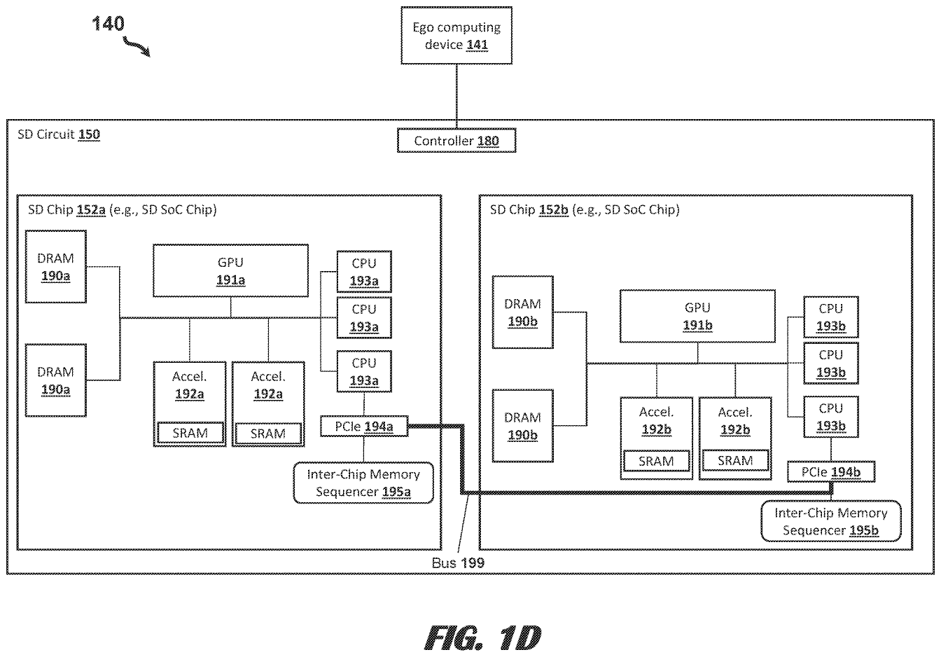

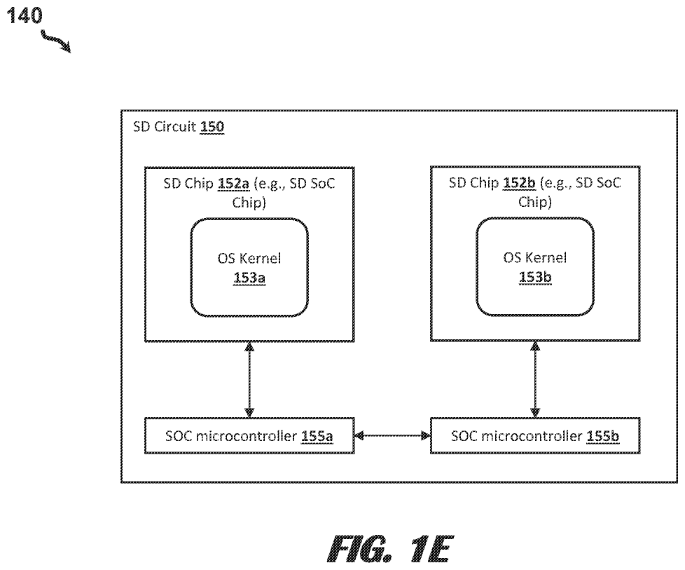

FIG. 1A is a non-limiting example of components of a system 100 in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a journey where egos 140 travel a route, regardless of whether the journey was autonomous or controlled by a human. In some embodiments, the navigation session may be for data collection and model training purposes. However, in some other embodiments, the egos 140 may refer to a vehicle purchased by a consumer and the purpose of the journey may be categorized as everyday use. The navigation session may start when the egos 140 move from a non-moving position beyond a threshold distance (e.g., 0.1 mi, 100 ft) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 1701 may monitor seatbelt detection and locking/unlocking assemblies, as well as other passenger restraint subsystems. The occupant restraint sensor 1701 may include various environmental and/or status sensors, actuators, and/or other devices facilitating the operation of safety mechanisms associated with the operation of the egos 140. For example, occupant restraint sensor 1701 may be configured to receive motion and/or status data from other sensors depicted in FIG. 1B. The occupant restraint sensor 1701 may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 1700 configured to use data collected via various sensors (e.g., radar 170n, speed sensor 170d, and/or ultrasound sensors 170p) to autonomously navigate the ego 140.

Therefore, autonomous driving or steering system 1700 may analyze various data collected by one or more sensors described herein to identify driving data. For instance, autonomous driving or steering system 1700 may calculate a risk of forward collision based on the speed of the ego 140 and its distance to another vehicle on the road. The autonomous driving or steering system 1700 may also determine whether the driver is touching the steering wheel. The autonomous driving or steering system 1700 may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A-1D (e.g., a processor of the egos 140).

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass.

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with a LiDAR that identifies a mass by emitting laser pulses and measuring the time it takes for these pulses to travel to an object (having mass) and back. LiDAR sensor systems may operate based on the principle of measuring the distance between the LiDAR sensor and objects in its field of view. This information, combined with other sensor data, may be analyzed to identify and characterize different masses or objects within the surroundings of the one or more of the egos 140.

Various additional data may be used to indicate whether a voxel of the one or more egos 140 surroundings is occupied by an object having mass or not. For instance, in some embodiments, a digital map of the surroundings (e.g., a digital map of the route being traversed by the ego) of the one or more egos 140 may be used to determine the occupancy status of each voxel.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

After the AI model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a journey) can then be fed back into the AI model(s) 110c, such that the additional data can improve the AI model(s) 110c.

FIG. 1D shows certain hardware and software components of the ego 140 for performing, full or partial, self-driving (SD) operations, according to an embodiment. The ego 140 comprises an SD circuit 150 and the ego computing device 141, which may include the same or different components of the SD circuit 150. The SD circuit 150 includes SD chips 152a-152b (generally referred to as SD chips 152), such as system-on-chip (SoC) integrated circuit chips. Each SD chip 152 includes non-transitory machine-readable memories, such as DRAMs 190a-190b (generally referred to as DRAMs 190) and SRAMs. The SD chip 152 further includes various types of processing units, including a GPU 191, CPUs 193a-193c (generally referred to as CPUs 193), and specially designed AI accelerator devices 192a-192b (generally referred to as AI accelerator devices 192). The SD chips 152 include an inter-chip interface 194a-194b (generally referred to as chip interfaces 194), such as a Peripheral Component Interconnect (PCI) or PCI-Express (PCIe). The SD chips 152 communicate signals via an inter-chip bus 199, according to the protocols and programming of the chip interfaces 194.

As mentioned with respect to FIG. 1A, the analytics server 110 (or other computing device) may compile and download the compiled execution binaries of the software for the neural network architectures to the ego 140 and/or the ego computing device 141. The ego computing device 141 may generate and/or execute various software programming operations and execution binaries for managing operations of the SD circuit 150 (or other hardware), which may include execution instructions for applying the neural network architecture on the types of sensor data from the sensors of the ego 140. The executable instructions received, generated, and/or executed by the ego computing device 141 may include executable instructions for managing operations of the components of the SD circuit 150. For instance, the compiled executable binaries may include instructions that, for example, indicate destination SD chips 152 for transferring data signals between the SD chips 152 via the bus 199, or indicate execution SD chips 152 for performing the functions of certain neural network architectures. For instance, instructions generated and compiled for a neural network architecture for recognizing traffic sign objects using data from the cameras 170m may be loaded into and executed by the components of a first SD chip 152a, where instructions compiled for a neural network architecture for path planning may be loaded and executed by the components of a second SD chip 152b. If the path planning neural network architecture is trained to use data outputs produced by the traffic sign neural network architecture, then the instructions of the first SD chip 152a instruct the first SD chip 152a to transfer the output data signals, via the bus 199, to the second SD chip 152b; and the instructions for the second SD chip 152b instruct the second SD chip 152b to use such data signals received from the first SD chip 152a.

In the example embodiment, the SD circuit 150 comprises two SD chips 152a-152b. In many cases, the SD chips 152 function in a redundancy mode or failover mode of operation, where a first SD chip 152a functions as a primary chip and a second SD chip 152b functions as a secondary chip. For example, the first SD chip 152a is prioritized to execute most of the executable instructions, and the second SD chip 152b is invoked to operate as failover or redundancy in the event of problems with the first SD chip 152a.

The SD circuit 150 may operate in an extended compute mode that balances the execution instruction pipelines amongst SD chips 152. As an example, the ego computing device 141 executes software routines for compiling the execution instructions to be performed by the processing units 191-193 of the SD chips 152 and distributing the execution instructions to the optimal hardware components of the SD circuit 150.

The SD chips 152 include inter-chip memory sequencers 195a-195b (generally referred to as inter-chip memory sequencers 195). The inter-chip memory sequencer 195 includes a hardware IC device that is used to coordinate the communication of signals between System-on-Chips (SoCs), such as the SD chips 152. In some implementations, the inter-chip memory sequencers 195 may include a non-transitory storage location that provides a shared memory space accessible by the SD chips 152. In some implementations, the inter-chip memory sequencer 195 executes operations that coordinate the data signal transfers between the SD chips 152 by, for example, generating various control signals. The inter-chip memory sequencers 195 may implement one or more inter-chip communication protocols, such as PCIe, SPI, or I2C, among others.

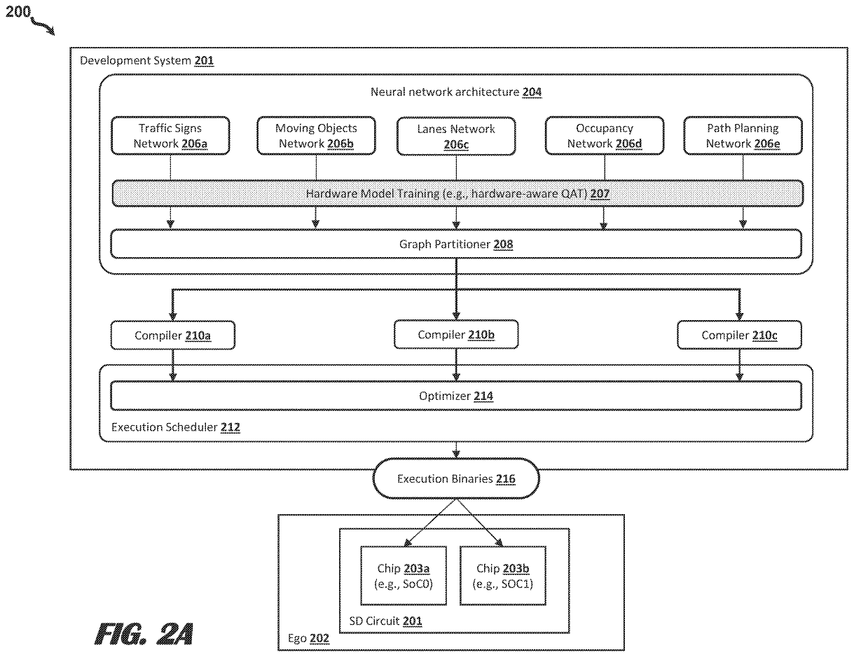

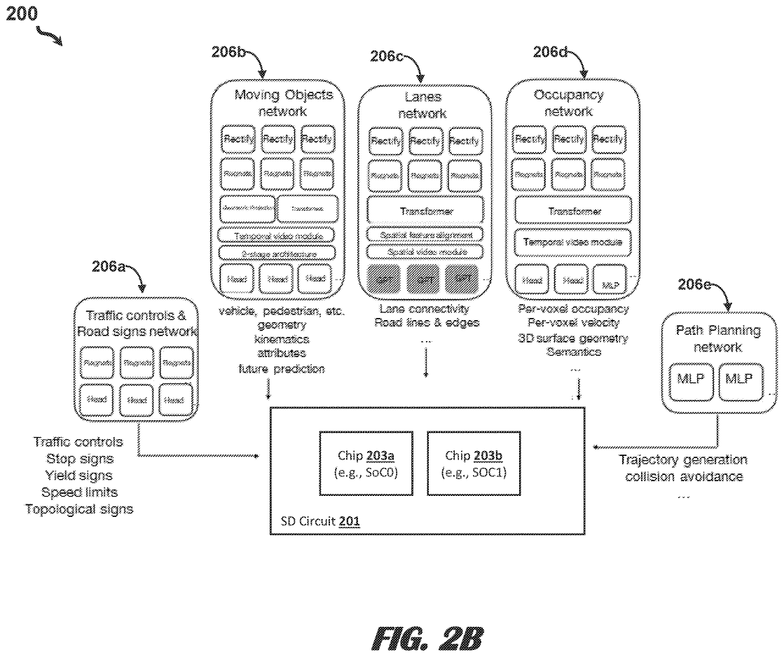

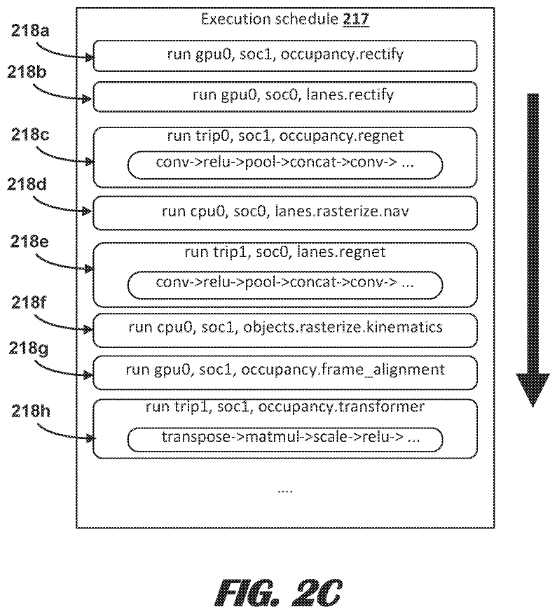

Hardware and software components of a runtime system of the ego 140 (e.g., ego computing device 141, SD circuit board 150, controller 180) receives a compile program schedule (e.g., execution instructions 218a-218h of execution schedule 217 of FIGS. 2A-2C), which may be in the form of execution binaries 216, and runs the execution instructions on the various types of heterogenous cores (e.g., processing units 190-193 of each chip 152) and across the various chips 152 of the circuit 150. The runtime system (represented as being executed by controller 180) contains software components for an inter-chip compute scheduler, heterogenous hardware scheduler (e.g., CPU accelerator, GPU accelerator, AI accelerator), inter-chip memory sequencers 195 for scheduling and managing inter-chip signals via the chip interface 194 and bus 199, and a clock synchronizer (e.g., OS kernel). In some implementations, the runtime system programming supports model parallelism across multiple SD chips 152. In this way, the ego 140 may review and go deep on the clock synchronizer.

In some embodiments, the ego 140 comprises a controller 180 that performs various operations for managing the SD circuit 150. The controller 180 may perform various functions according to, for example, instructions from the ego computing device 141 (or other component of the ego 140) or configuration inputs from an administrative user. For instance, the controller 180 toggles, configures, or otherwise instructs the SD circuit 150 to operate in the various operational modes. In some circumstances, for example, the controller 180 instructs the SD circuit 150 to operate in an extended compute mode in which the first SD chip 152a executes a first instruction partition of the execution instructions and the second SD chip 152b executes a second instruction partition. As another example, in some circumstances, the controller 180 instructs the SD circuit 150 to operate in a failover mode in which the second SD chip 152b executes the execution instructions when the first SD chip 152a fails.

The SD chip 152 includes one or more DRAMs 190 or other types of non-transitory memories for storing data inputs for the SD chip 152. The data inputs may be stored in the DRAM 190 for the processing units to reference for various computations. In some configurations, the AI accelerator devices 192 include SRAMs, such that the SD chip 152 moves the data from a DRAM 190 for storage into the SRAM of the AI accelerator device 192. The AI accelerator device 192 executes the computation according to the execution instructions and moves the data back to the DRAM 190 or other destination of the SD circuit 150.

The SD chip 152 includes various types of processing units, which may include any hardware integrated circuit (IC) processor device capable of performing the various processes and tasks described herein. Non-limiting examples of the types of processing units include GPUs 191, CPUs 193, AI accelerator devices 192, microcontrollers, ALUs, ASICS, and FPGAs, among others. The processing units may perform the computational functions of the programming layers defining the neural network architectures or sub-architectures. The compilers output the execution instructions representing the operations of the neural network architecture, executed by the ego computing device 141 (or other components of the ego 140).

The AI accelerator devices 192 are hardware accelerators designed specifically for the neural network operations, beneficially focusing on improvements to, for example, optimizing power and performance (e.g., low latency). The AI accelerator devices 192 include hardware IC devices (e.g., microcontrollers, ALUs, ASICs, FPGAs, processor devices) designed for fast operations when processing neural network architectures. For instance, as transformer neural network architectures (e.g., GPTs) and other types of neural network modeling techniques grow more popular, other types of processing units (e.g., CPUs 193, GPUs 191) may be slower due to a theory of design intended for broader implementation use cases. For instance, a neural network architecture, sub-neural network (e.g., moving objects network 206b of FIG. 2B), or child neural network performs computer vision or object recognition by implementing various GPTs (or other types of transformers) on the image sensor data, beneficially replacing previous techniques for post-processing of vision neural networks. The AI accelerator device 192 is designed specifically for neural network operations allowing the GPT transformers to run natively in the computing components of the ego 140, such that the AI accelerator devices 192 provide faster and more efficient processing than traditional GPUs 191 or CPUs 193 executing similar GPT transformations. In this way, the AI accelerator devices 192 mitigates or eliminates latency and improves overall efficiency, contributing to the ability of the ego 140 to make real-time decisions. Moreover, the structural design and design theory of the AI accelerator devices 192 draw comparatively less power than traditional GPUs 191 or CPUs 193 when performing more sophisticated and complex functions of neural network architectures, such as the transformer networks (e.g., transformers).

In some embodiments, the transformers (e.g., GPT) may be adapted for execution in the ego 140, improving overall performance of computing components for autonomous or semi-autonomous egos 140. For instance, typical transformers are often resource intensive, consume a lot of power, and/or cause substantial latency in processing outputs, and thus hinder overall performance of the ego 140. As such, transformers are powerful neural network architectures that are often not deployed in egos 140. To address this problem, the transformers of the egos 140 described herein may be deployed without an attention module softmax that is often found in conventional transformers. Embodiments described herein may include transformers having softmax-free attention, and may implement ReLU activations. By replacing softmax with ReLU in such transformers, it now becomes feasible to deploy transformer architectures in autonomous or semi-autonomous egos 140.

In some embodiments, an SD circuit includes a controller or other processing unit that maintains clock synchronization between the SOC chips based upon interpreting timestamps of sensor inputs (e.g., timestamps of camera inputs) and translating the timestamps between the SOC chips according to a difference between each SOC chip's current chip-clock.

FIG. 1E shows certain hardware and software components of the ego 140 for maintaining clock synchronization between the SD chips 152, according to an embodiment. In such embodiments, the SD circuit 150 includes two (or more) SD chips 152 and two (or more) microcontrollers 155a-155b (generally referred to as microcontrollers 155) coupled to corresponding microcontroller 155. For instance, a first SD chip 152a is coupled to a first microcontroller 155a and a second SD chip 152b is coupled to a second microcontroller 155b. Each SD chip 152 comprises and executes a OS kernel 153 that manages operations of the SD chip 152, including executing the various execution instructions of the neural network architectures and managing operations of the SD chip 152.

The OS kernel 153 may comprises any type of OS capable of performing various processes and tasks described herein, including managing execution of the execution instructions and maintaining a software-based OS clock. The OS of the OS kernel 153 includes, for example, Linux, Unix, or the like.

The microcontroller 155 comprises any type of processing circuit unit capable of performing the various processes and tasks described herein. Non-limiting examples include a microcontroller, controller, ALU, FPGA, ASIC, or the like. The SOC chip 152 comprises one or more processing units that execute the OS kernel 153 (e.g., Linux), and one or more smaller microcontrollers 155. The microcontroller 155 includes low-level programming for performing various low-level functions. For instance, a function the microcontroller 155 includes a bootloader function in which the microcontroller 155 boot various components of the SD chip 152, which includes botting the processing unit that executes the OS kernel 153. In some embodiments, the microcontroller 155 or other device of the SD circuit 150 may include or couple to a clock oscillator or counter that oscillates or increments a monotonic clock at a given frequency.

The microcontrollers 155 may communicate with the processing unit executing the OS kernel 153 via a given interface (e.g., Mailbox, Ethernet, UART, PCIe) to exchange data signals, such as time messages or correction instructions. Likewise, the first microcontroller 155a may communicate with the second microcontroller 155b via another interface (e.g., Mailbox, Ethernet, UART, PCIe) to exchange time messages or correction instructions.

Generally, the microcontrollers 155 execute the bootloader function to boot the microcontrollers 155 and the OS kernels 153 contemporaneously and at a relatively early moment in time after starting the ego 140. At boot time, the microcontrollers 155 and OS kernels 153 communicate various timing messages in order synchronize to each other. In this way, the boot and synchronization functions of the microcontrollers 155 logically form a common monotonic time clock for the SD circuit 150, before the processor units of the OS kernels 153 have a chance to start executing.

When programming of the OS kernel 153 (e.g., Linux) starts to boot on the processor, early in the boot of the OS kernel 153, the OS kernel 153 resets a monotonic kernel clock of the OS kernel 153. The OS kernel 153 may reset the kernel clock to match the controller clock of the corresponding microcontroller 155. This reset may occur before anything or before a large amount of operations have had an opportunity to start on the SD chips 152, or not much has started in the OS kernel 153. When the OS kernel 153 boots, the OS kernel 153 synchronizes the kernel clock to the corresponding microcontroller 155.

In some implementations, at a preconfigured re-synchronization period or threshold time, the SD chips 152 and microcontrollers 155 actively maintain synchronized kernel clocks and controller clocks through a control loop operation in which the SD chips 152 and microcontrollers 155 exchange timing messages. For instance, at the synchronization interval (e.g., once per second), the OS kernels 153 will measure a time error with respect to the corresponding microcontrollers 155 and, in some circumstances, an OS kernel 153 instructs the connected microcontroller 155 to initiate a small adjustment to correct the controller clock.

In some embodiments, the clock synchronization operations include a redundancy fallback function. In certain circumstances, a SD chip 152 (e.g., second SD chip 152b) may suffer a fatal error and must reboot, while the other SD chip 152 (e.g., first SD chip 152a) may continue operating, until the rebooted SD chip 152 (e.g., second SD chip 152b) recovers. In such circumstances, the operational SD chip 152 (e.g., first SD chip 152a) continues to maintain the kernel clock of the OS kernel 153 (e.g., first OS kernel 153a) and the controller clock of the corresponding microcontroller 155 (e.g., first microcontroller 155a), and thus, by extension, maintains the overall logical synchronized clock for the SD circuit 150. As such, when the rebooted SD chip 152b recovers, the overall synchronization may continue through, for example, the synchronization messages between the first microcontroller 155a and the second microcontroller 155b. The rebooted SD chip 152b need not restart a new kernel clock and a new controller clock at zero or some other initialized time. The microcontroller 155b and the OS kernel 153b may start the kernel clock and the controller clock at a current, monotonic time of the overall synchronized clock for the SD circuit 150. The microcontroller 155b may execute recover, reboot, or boot processes that include a synchronization process with the operational microcontroller 155a, in which the microcontrollers 155 exchange time messages to indicate the current time of the controller clock of the operational microcontroller 155a, which reflects the overall synchronized clock for the SD circuit 150. The recovered microcontroller 155b and the recovered OS kernel 153b may then exchange time messages that indicate the current time of the controller clocks of the microcontrollers 155, which reflects the overall synchronized clock of the SD circuit 150. In this way, the components of the SD circuit 150 need not compute, distribute, or translate time-differences between discontinuous clocks of the SD chips 152. After rebooting, the application software executing in the recovered SD chip 152b and the recovered OS kernel 153b may begin executing and participating nearly immediately, with limited delay to rebuild the state before the fault and/or without ongoing latency due to continuous computations for translating what would be discontinuous clocks. This beneficially improves fault tolerance and supports failover redundancies for the ego 140.

The OS kernel 153 and/or microcontroller 155 may execute error correction functions that adjusts the frequency of the controller clock by relatively small amounts, such that the microcontroller 155 or the OS kernel 153 increases or decreases the frequency and clock time (e.g., controller clock, kernel clock) by some amount.

As mentioned, each SD chip 152 has multiple types of synchronization operations, including a kernel-to-controller synchronization operation between the OS kernel 153 and the corresponding microcontroller 155; and an SOC synchronization or controller-to-controller synchronization operation between the microcontrollers 155 of the SD chips 152.

In a first type of synchronization operation (e.g., synchronizing an OS kernel 153a with the corresponding microcontroller 155a), the OS kernel 153 sends a timing message to the microcontroller 155. The OS kernel 153 of the SD chip 152 and the microcontroller 155 each includes a communications interface (e.g., Mailbox, Ethernet, UART, PCI) for exchanging timing messages (or other types of messages) via a signal connection, wire, or bus, according to the protocols of the particular interface.

At boot time and/or at the preconfigured interval, the OS kernel 153 transmits a timing message to the microcontroller 155 and receives a return timing message from the microcontroller 155, and references related clock times to determine whether the one or more clocks have drifted beyond a threshold distance. The OS kernel 153 sends the initial timing message at a first time (T1) to the microcontroller 155. The OS kernel 153 references the kernel clock to retrieve the current time and assign the current time as an initial message time (T1) for the initial timing message. The microcontroller 155 receives the initial timing message and references the current time of the controller clock of the microcontroller 155. The microcontroller 155 sends a response timing message at a response time (T2) to the OS kernel 153. The OS kernel 153 assigns the response time to the response timing message according to the current time of the controller clock. The OS kernel 153 receives the response timing message indicating the response time (T2), and references the kernel clock to retrieve the current time of the kernel clock. When the OS kernel 153 receives the response message, the OS kernel 153 assigns the current time of the kernel clock as a completion time (T3) to the response timing message. The OS kernel 153 computes an average time based upon an average of the kernel times, which include the initial message time (T1) and the completion time (T3). The OS kernel 153 then compares this average time against the response time (T2) received from the microcontroller 155, to compute and output the difference between the average time and the response time. In an example configuration, a first OS kernel 153a may compute an offset representing an estimated amount of time error between the first monotonic kernel clock of the first OS kernel 153a and the first monotonic controller clock of the first microcontroller 155a. In this example configuration, the offset is computed the difference between the average time and the response time.

In a second type of synchronization operation (e.g., synchronizing a first microcontroller 155a with the second microcontroller 155b), the OS kernel 153 sends a timing message to the microcontroller 155. The microcontrollers 155 each include a communications interface (e.g., Mailbox, Ethernet, UART, PCI) for exchanging timing messages (or other types of messages) with other microcontrollers 155 via a signal connection, wire, or bus, according to the protocols of the particular interface.

At boot time and/or the preconfigured interval, the microcontrollers 155 automatically begin exchanging timing messages with one another. The microcontrollers 155 need not establish a handshake, or exchange any antecedent or predicate communications; the microcontrollers 155 may being sending the timing messages. Each microcontroller 155 uses the timing messages to capture and determine the message time (T1) and the completion time (T3), and receive the response time (T2) returned from the other microcontroller 155. Each microcontroller 155 may then compute the offset as described above with respect to the OS kernels 153. So each microcontroller 155 can estimate the offset relative to the peer microcontroller 155. And they just do this automatically.

In some circumstances, a particular microcontroller 155 rebooted and recovered. In such circumstances. the reboot or recovery functions of the recovered microcontroller 155b may function as a follower to the operational microcontroller 155a, which functions as master. The first microcontroller 155a and second microcontroller 155b treat the controller clock of the first microcontroller 155a as the master controller clock. At reboot and recover, the first microcontroller 155a and second microcontroller 155b exchange timing messages that assign the controller clock of the first microcontroller 155a directly to the controller clock of the second microcontroller 155b.

In some implementations, one or more offsets representing the difference between two clocks is transmitted to, for example, a Proportional Integral (PI) controller or Phase-Locked Loop (PLL) controller as an error signal. Using known algorithmic techniques, the PLL or PI controller may compute an error rate based upon the offset, where the input is an offset taken as a phase and the output is the rate. The error rate is the rate that the OS kernel 153 (or microcontroller 155) must correct. At every instance or interval (e.g., every second) a new measurement is computed of the rate, the rate difference (offset) between the two clocks, the OS kernel 153 (or microcontroller 155) may adjust the kernel clock (or controller clock) by applying that rate to the kernel clock (or controller clock). As an example, if the computed rate indicates that the kernel clock of the first OS kernel 153a is two parts-per-million faster than the first microcontroller 155a, then the first OS kernel 153a adjusts to a new frequency that matches two parts-million slower frequency in the first OS kernel 153a in order to meet the frequency oscillation of the first microcontroller 155a.

A first microcontroller 155a transmits a timing message to the second microcontroller 155b and receives a return timing message from the second microcontroller 155b, and references related clock times to determine whether the one or more clocks have drifted beyond a threshold distance. The first microcontroller 155a sends the initial timing message at a first time (T1) to the second microcontroller 155b. The OS kernel 153 references the kernel clock to retrieve the current time and assign the current time as an initial message time (T1) for the initial timing message. The microcontroller 155 receives the initial timing message and references the current time of the controller clock of the microcontroller 155. The microcontroller 155 sends a response timing message at a response time (T2) to the OS kernel 153. The OS kernel 153 assigns the response time to the response timing message according to the current time of the controller clock. The OS kernel 153 receives the response timing message indicating the response time (T2), and references the kernel clock to retrieve the current time of the kernel clock. When the OS kernel 153 receives the response message, the OS kernel 153 assigns the current time of the kernel clock as a completion time (T3) to the response timing message. The OS kernel 153 computes an average time based upon an average of the kernel times, which include the initial message time (T1) and the completion time (T3). The OS kernel 153 then compares this average time against the response time (T2) received from the microcontroller 155, to compute and output the difference between the average time and the response time. In an example configuration, a first OS kernel 153a may compute an offset representing an estimated amount of time error between the first monotonic kernel clock of the first OS kernel 153a and the first monotonic controller clock of the first microcontroller 155a. In this example configuration, the offset is computed the difference between the average time and the response time.

FIGS. 2A-2B depicts data flow amongst hardware and software computing components of a system 200 for developing and compiling executable instructions 218a-218h (generally referred to as execution instructions 218) at a development system 201 to be loaded as execution binaries 216 to an ego 202, according to an embodiment. FIG. 2C illustrates the execution instructions 218 generated and organized into an execution schedule 217 for execution by circuit hardware components of the system 200, according to the embodiment.

One or more computing devices (e.g., analytics server 110) of the development system 201 may execute software programming defining one or more neural network architectures 204, a hardware model training engine 207, compilers 210, and an execution scheduler 212, among other types of software programming routines. In addition, the computing device(s) of the development system 201 may execute software programming for training, re-training, and tuning the neural network architecture 204 or portions (e.g., parameters, hyper-parameters, weights, layers, functions) of the neural network architecture 204 on various forms of historic and/or current sensor data from any number of egos 202 for prediction accuracy and consistency. Additionally or alternatively, the computing device(s) of the development system 201 may execute software programming for training, re-training, and tuning the neural network architecture 204 or portions (e.g., parameters, hyper-parameters, weights, layers, functions) of the neural network architecture 204 on various types of input data, output data, or prediction data of the neural network architecture 204 that is relative or scaled to, or optimized for, for example, data sizes and formats implemented by hardware components of the ego 202.

During training or inference time, the computing device(s) of the development system 201 extracts features or tensors from the input data, such as historic or current sensor data gathered from the sensors of the egos 202 or retrieved from a database of the development system 201 containing historic data captured by the egos 202. The computing device(s) of the development system 201 feeds the input data to the neural network architecture 204 or sub-architectures for various operations (e.g., computer vision, object recognition), and applies the neural network architecture 204 on the input data to generate predicted outputs and, during training, adjust or re-train the portions (e.g., parameters, hyper-parameters, weights, layers) of the neural network architecture 204.

The computing device(s) of the development system 201 applies a graph partitioner on the sensor data to generate data partitions or portions. The ego computing device 141 applies a set of compilers (not shown), which may logically form a compiler toolchain for the neural network architecture of the ego 202, for compiling and debugging the code for executing layers of the neural network architecture for sensor-data interpretation. Each compiler is used to transform the high-level programming language into machine code comprising execution instructions, executed by the hardware of the SD circuit 150. The compilers may be configured or optimized to compile the programming code according to the specific architectures or types of the processing units (e.g., CPU 193, GPU 191, or specialized AI accelerator device 192 hardware) of the SD chips. The schedule optimizer of the execution scheduler may combine multiple compiled pieces of code (e.g., executable instructions) into one or more executable files or data stream for an execution schedule (not shown).

The schedule optimizer and execution scheduler obtains the set of execution instructions and maps the execution instructions into the hardware components (e.g., GPUs 191, AI accelerator devices 192, CPUs 193) of the SD circuit to perform the particular execution instructions. In some implementations, the schedule optimizer of the execution scheduler is trained to optimize the operations to be performed in the hardware components of the SD circuit. The schedule optimizer is trained to determine or preconfigured with temporal or latency demands for the hardware components to perform the operations of the execution instructions. This often possible because such performance-timing or latency metrics are known, essentially static, quickly calculated, or prestored. In this way, the schedule optimizer maps the execution instructions to the components of the SD circuit according to the minimized or optimized latency. Additionally or alternatively, the schedule optimizer determines which hardware components of the SD circuit should perform which execution instructions based upon characteristics of the execution instructions (e.g., which compiler generated the machine code of the execution instruction). In this way, the schedule optimizer maps the execution instructions to the processing units based upon the compiler that generated the particular execution instruction.

As shown in FIG. 2A, the system 200 includes the software programming for executing a neural network architecture 204 at the computing device(s) of the development system 201, including various domain-specific or task-specific sub-networks 206a-206e (generally referred to as sub-networks 206), though other types of machine-learning architectures may be included. The source code of the software programming define the aspects (e.g., parameters, hyper-parameters, weights, layers, functions) of the neural network architecture 204, which includes the source code defining any number of sub-networks 206, including a traffic signals network 206a, a moving objects network 206b, a lanes network 206c, an occupancy network 206d, and a path-planning network 206e for performing operations for a particular domain or task, though embodiments may include additional or alternative types of sub-networks 206. The software components of the development system 201 may further include the compilers 210, the hardware model training engine 207, and an execution scheduler 212 that includes functions defining a schedule optimizer 214.

During training of the neural network architecture 204 and sub-networks 206, the development system 201 executes the hardware model training engine 207 to train the sub-networks 206 on a model or representational data for the components of the hardware of the ego 202. In this way, the hardware model training engine 207 provides quantization aware training (QAT) for the neural network architectures 204, such that the sub-networks 206 may be optimized for the hardware components of the ego 202 and quantization resilient. Beneficially, QAT functions of the hardware model training engine 207 train the neural network architecture 204 and sub-networks 206 to be more efficient and smaller in size. The QAT functions of the hardware model training engine 207 train the sub-networks 206 by applying the sub-networks 206 on various or desired quantized weights (e.g., 16-bit floating point values; 8-bit floating point values; 8-bit integer) and activations (e.g., 16-bit floating point values; 8-bit floating point values; 8-bit integer). The QAT functions of the hardware model training engine 207 force the neural network architecture 204 and/or each sub-network 206 to learn to operate with lower precision numbers. For example, the hardware model training engine 207 may train the sub-networks 206 to ingest or produce 8-bit floating point or integer values, rather than, for example, ingesting or producing 16-bit floating point or integer values.

Beneficially, by the hardware model training engine 207 may improve efficiency and reduce demand on computing resources on the ego 202 by working with smaller quantized data sizes. Additionally, this may reduce the power consumption required by the hardware of the ego 202. For instances, by training the neural network architectures 204 to be quantization aware or resilient, the neural network architecture 204 and hardware executing the compiled neural network architecture 204 operates sufficiently on lower precision data values or primitives. In this way, the hardware of the ego 202 may run the neural network architectures 204 trained and compiled at a lower precision at a comparatively lower power consumption than otherwise used if the hardware of the ego 202 runs the neural network architectures 204 trained and compiled at the higher precision.

The neural network architecture 204 may include, or connect to, neural network of a graph partitioner 208. The graph partitioner 208 may partition sensor data received via ingestion layers 202 to the sub-networks 206 for processing the sensor data. The neural network architecture 204 is logically partitioned into the sub-networks 206. The neural network layers of the graph partitioner 208 are trained to parse the sensor data into data portions and then map the data portions to the sub-networks 206 to perform the functions of the particular sub-networks 206. The graph partitioner 208 maps the sensor data portions to the sub-network 206 according to, for example, types of data or features in the sensor data that are used by the sub-network 206.

After assigning the sensor data and functions to the sub-networks 206, the graph partitioner 208 may then assign which hardware components of an SD circuit 201 should realize and execute the functions of the sub-networks 206. The neural network layers of the graph partitioner 208 are trained to assign the sensor data portions and the functions of the particular sub-networks 206 to the particular processing units (e.g., CPUs, GPUs, specialized hardware AI accelerator device) of chips 203a-203b (generally referred to as chips 203) (e.g., SoCs, SD chips) of the SD circuit 201. For example, the graph partitioner 208 is configured and trained to assign a comparatively simplistic function of a sub-network 206 using a sensor data portion to a CPU of a chip 203 and assign a comparatively complex function of another sub-network 206 using another sensor data portion to a AI accelerator device of a chip 203.

With reference to FIG. 2B, the domain-specific sub-networks 206 include the traffic signals network 206a, the moving objects network 206b, the lanes network 206c, the occupancy network 206d, and the path planning network 206e. The sub-networks 206 perform various types of domain-specific or task-related functions for a given purpose (e.g., object recognition, path planning) according to the software programming of the neural network layers of the particular sub-network 206. As an example, the functions of the traffic signs network 206a include recognizing certain objects image data (or other types of sensor data), such as traffic controls, stop signs, yield signs, speed signs, and topology signs in. As another example, the functions the occupancy network 206d include determining per-voxel occupancy, per-voxel velocity, and 3D surface geometry semantics, among other image-related metrics in the image data (or other types of sensor data). As another example, the functions of the path planning network 206e include generating a trajectory or path for navigating the ego, and adjusting the path for collision avoidance, among others, using the image data or other types of sensor data.

The sub-networks 206 perform various operations or functions for computing the sensor data and producing the output of the particular sub-network 206. In some cases, these functions include procedural computations or operations. In some cases, these functions include child neural networks of the particular sub-network 206. Non-limiting examples of the types of child networks of the sub-networks 206 include ingestion or intake layers (sometimes called “head layers”), Rectify layers, Regularized Neural Networks (RegNet) layers, Transformer layers, and Multilayer Perceptron (MLP) layers, among others.

In some cases, the graph partitioner 208 is further configured and trained to assign the input sensor data portions to the particular sub-networks 206 based upon the types of child neural networks in the sub-networks 206. Additionally or alternatively, the graph partitioner 208 is trained to assign the functions and sensor data to the hardware of the SD circuit 201 based upon the capabilities of the hardware. For instance, the graph partitioner 208 is trained to optimize the efficiency of the hardware and/or reduce latency of the hardware, or achieve any additional or alternative performance behavior of the hardware. As an example, the graph partitioner 208 assigns a series of inter-related or dependent functions of a child network within a sub-network 206 to one or more CPUs of the same first chip 203a, which may improve efficiency. As another example, the graph partitioner 208 assigns complex functions of a sub-network 206 to a AI accelerator device of a chip 203, which may improve computation speeds. The graph partitioner 208 may be trained to maximize or minimize a performance metric, or the graph petition may be trained to balance and optimize according to multiple performance metrics.

Turning back to FIG. 2A, the system 200 includes a compiler toolchain comprising a set of compilers 210a-210c (generally referred to as compilers 210). The compilers 210 include software programming configured to transform the high-level programming language of the layers and functions of the neural network architecture 204 and the sensor data into machine code of execution instructions 218 that can be executed by the hardware of the SD circuit 201. The system 200 includes a heterogenous collection of processing units and compilers 210, where the compilers 210 are configured for transforming from a given high-level programming language (e.g., functions of the sub-networks 206 and sensor data portions) into a given machine code (e.g., execution instruction 218) compatible with the assigned processing unit. In some embodiments, the software routines of a compiler 210 may selectively compile the machine code for more than one type of processing unit, such that the compiler 210 may generate the execution instructions 218 for more than one type of processing unit (e.g., CPUs, GPUs, AI accelerator devices).

The graph partitioner 208 (or other component of the system 200) is configured and trained to identify which compiler 210 should be assigned to compile which functions of the sub-networks 206. For instance, continuing with the earlier example, the graph partitioner 208 is configured and trained to assign the comparatively simplistic function of the sub-network 206 to a first compiler 210a programmed to generate execution instructions 218 for the CPUs, and assign the comparatively complex function of the other sub-network 206 to a second compiler 210b programmed to generate execution instructions 218 for the AI accelerator devices. The outputs of the compilers 210 are the execution instructions 218 compiled from the sensor data portion and the software programming for the functions of the sub-networks 206.

The system 200 includes an execution scheduler 212 neural network, which includes layers defining a schedule optimizer 214 (sometimes referred to as a “linker”). The schedule optimizer 214 of the execution scheduler 212 may combine multiple compiled pieces of code (e.g., executable instructions 218) generated by the compilers 210 of the compiler toolchain into one or more execution binaries 216, comprising one or more executable files or data stream of the execution instructions 218. The execution scheduler 212 may arrange or queue the execution instructions 218 for ordered execution by the hardware of the SD circuit 201.

The execution binary 216 is downloaded from the software of the system 200 to a non-transitory memory of the hardware of the SD circuit 201. In the SD circuit 201, a software-based or firmware-based controller component of the SD circuit 201 parses the execution instructions 218 of the execution binary 216 and loads the execution instructions 218 into one or more non-transitory memories (not shown) accessible to the assigned processing units of the chips 203 (or other hardware components). The processing units then execute the execution instructions 218 to perform the functions of the neural network architecture 204.

With reference to FIG. 2C, in some cases the execution instructions 218 generated by the compilers 210 may be arranged and logically represented as an execution schedule 217. The outputs of the compiler toolchain include the execution instructions 218 for the functions of the sub-networks 206. For ease of understanding, the execution instructions 218 in FIG. 2C show the chip 203 assigned to perform the operation, the processing unit (e.g., GPU, CPU, AI accelerator device) assigned to perform the operation, and which neural network architecture's functions will be performed. However, the execution instructions 218 of potential embodiments may include additional or alternative types of information, such as input data sources or interfaces, output data destinations or interfaces, and computational instructions.

As an example, a first execution instruction 218a indicates that a first GPU (gpu0) of the second chip 203b (SoC1) is assigned to perform the functions. The first execution instruction 218a instructs the first GPU of the second chip 203b (i.e., run gpu0, soc1) to perform functions of a Rectify neural network architecture within the occupancy network 206d.

Downstream hardware and software of the ego may ingest the outputs generated by the SD circuit 201 executing the neural network architecture 204, such as trajectory, speed, and other navigational determinations of the path planning network 206e, to operate or maneuver the ego within the environment.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
obtaining, by a computer, software programming comprising a plurality of functions of a plurality of sub-neural networks of a neural network architecture;
assigning, by the computer, the one or more sub-neural networks to a plurality of processing units of the ego, wherein for each sub-neural network the computer assigns a processing unit to compute the plurality of functions of the sub-neural network; and
generating, by the computer, a plurality of execution instructions for the plurality of processing units by executing a plurality of compilers on the plurality of functions of each sub-network, wherein for each execution instruction the computer uses a compiler of the plurality of compilers according to the processing unit of the ego assigned to the plurality of functions of the sub-neural network.

2. The method of claim 1, further comprising generating, by the computer, a computer file comprising the plurality of execution instructions for the plurality of processing units to execute the plurality of sub-neural networks.

3. The method of claim 1, further comprising transmitting, by the computer, the computer file to the ego.

4. The method of claim 1, wherein at least one execution instruction causes a circuit of the ego comprising the plurality of chips to operate in an extended compute mode for parallel execution of the plurality of execution instructions.

5. The method of claim 1, wherein at least one execution instruction instructs a circuit of the ego comprising a plurality of chips including the plurality of processing units to operate in a redundancy mode for primary execution of the plurality of execution instructions by a primary chip of the plurality of chips.

6. The method of claim 1, further comprising applying, by the computer, a schedule optimizer engine on the execution instructions to generate an execution schedule of the execution instructions, the schedule optimizer engine comprising neural network layers trained to generate the execution schedule for minimizing latency.

7. The method of claim 1, wherein the one or more processing units includes at least one of a GPU, a CPU, or an accelerator device.

8. The method of claim 1, wherein the one or more processing units are heterogenous, including at least two types of processing units.

9. The method of claim 1, wherein the computer assigns the processing unit of the plurality of processing units of the ego to apply the sub-neural network according to one or more graphs representing a circuit architecture of the ego having the plurality of processing units.

10. The method of claim 1, further comprising training, by the computer, the one or more sub-neural networks for quantization awareness training based upon the one or more processing units, by applying each sub-neural network on a training dataset comprising data with an intended quantization characteristic.

11. A system comprising:
a computer comprising a processor, configured to:
obtain software programming comprising a plurality of functions of a plurality of sub-neural networks of a neural network architecture;
assign the one or more sub-neural networks to a plurality of processing units of the ego, wherein for each sub-neural network the computer assigns a processing unit to compute the plurality of functions of the sub-neural network; and
generate a plurality of execution instructions for the plurality of processing units of the ego by executing a plurality of compilers on the plurality of functions of each sub-neural network, wherein for each execution instruction the computer uses a compiler of the plurality of compilers according to the processing unit of the go assigned to the plurality of functions of the sub-neural network.

12. The system of claim 11, wherein the computer is further configured to generate a computer file comprising the plurality of execution instructions for the plurality of processing units to execute the plurality of sub-neural networks.

13. The system of claim 11, wherein the computer is further configured to transmit the computer file to the ego.

14. The system of claim 11, wherein at least one execution instruction causes the plurality of chips of the ego to operate in an extended compute mode for parallel execution of the plurality of execution instructions.

15. The system of claim 11, wherein at least one execution instruction causes the plurality of chips of the ego to operate in a redundancy mode for primary execution of the plurality of execution instructions by a primary chip of the plurality of chips.

16. The system of claim 11, wherein the computer is further configured to apply a schedule optimizer engine on the execution instructions to generate an execution schedule of the execution instructions, the schedule optimizer engine comprising neural network layers trained to generate the instructions for minimizing latency.

17. The system of claim 11, wherein the plurality of processing units includes at least one of a GPU, a CPU, or a accelerator device.

18. The system of claim 11, wherein the plurality of processing units are heterogenous, including at least two types of processing units.

19. The system of claim 11, wherein the computer assigns the processing unit of the plurality of plurality of processing units of the ego to the sub-neural network according to one or more graphs representing a circuit architecture of the ego having the plurality of processing units.

20. The system of claim 11, wherein the computer is further configured to train the one or more sub-neural networks for quantization awareness training based upon the one or more processing units, by applying each sub-neural network on a training dataset stored in a database, the training dataset comprising data with an intended quantization characteristic.
